(19) United States
(12) Patent Application Publication
(10) Pub. No.: US 2002/0156701 A1
(43) Pub. Date: Oct. 24, 2002

(54) Automated sales system for the moving and storage industry

(76) Inventor: Chris R. Fultz, San Bernardino, CA (US)

Correspondence Address: GARY CARY WARE & FREIDENRICH LLP, 1755 EMBARCADERO ROAD, PALO ALTO, CA, 94303-3340, US

(21) Appl. No.: 09/779,964

(22) Filed: Feb. 9, 2001

Related U.S. Application Data
(60) Provisional application No. 60/181,991, filed on Feb. 11, 2000.

(51) Int. Cl. G06F 17/60

(52) U.S. Cl. 705/27

(57) ABSTRACT

A process, method, and program for automating the gathering and processing of customer information and an automated estimating-communication device and mobile presentation platform for the field sales representative and office support staff in the moving and storage industry.

### CROSS-REFERENCE TO RELATED APPLICATIONS

This application claims priority to U.S. Provisional Patent Application No. 60/181,991, filed Feb. 11, 2000.

### BACKGROUND OF THE INVENTION

The personal nature of the services movers supply to the public necessitates that sales consultants frequently meet with a prospect in their home to plan, estimate, and present services. Each quotation and presentation is as individual as the client whose goods are being moved, however, in all cases the pricing is based on a list of goods to be shipped which the representative typically prepares prior to calculating prices and presenting their company's service offerings. Due to the complexity of the variety of pricing methods used (tariffs dictated by regulatory agencies like the DOT and PUC), in most cases the pricing of the proposal takes from fifteen minutes to one hour per job, when done by calculator and hand written on manual forms. To compete effectively in this market, representatives have to prepare these quotations on site. Most clients, after an hour or more of data gathering and waiting for the estimate, are not interested in hearing sales talk and want the representative to deliver the pricing information and let them get on with their business. This is the standard scenario and the paradigm affected by the use of the present invention.

### SUMMARY OF THE INVENTION

In the new scenario, the field rep picks up the customer appointment card and electronic estimate form from the office via e-mail or from the server in the office with a NIC (Network Interface Card) card LAN (Local Area Network) connection, or a wireless network connection. The office personnel can also transmit the file to the outside sales representative by any other electronic means, such as saving the file to a disk. The pickup and delivery information is filled in electronically by the customer service representative during his/her initial conversation with the prospect when customers call to inquire as to the availability of the company to service their transportation needs. By telephone most customers will schedule an appointment with a field salesperson to survey and estimate their needs and the cost of service.

Frequently some companies receive a commitment over the telephone and the sales call to sign the paperwork is a mere formality. Many clients have previously had estimates and are calling around to get additional rate quotes. The ability of a company to quickly and accurately quote and book shipments with the customers' supplied information often results in booking the order over the phone. Even the most complicated estimate, from anywhere to anywhere, can be generated by this invention, without reference to tariff schedules, mileage calculations, or tables, or manual calculations, as the invention supplies all necessary lookups for accurately pricing a shipment. In less than two minutes, if clients can answer specific questions regarding their service needs, the order can be generated and faxed to them for their approval. From the first call, this invention can create a perception of a higher level of competence in the eyes of the client. This gives a company a decided advantage over any other company the customer may have contacted. If the client prefers a sales call with a contract for an exact price, the phone sales representative then sets an appointment and saves the clients file. The file is then transmitted to the rep via one of the methods outlined above.

The sales rep then arrives at the residence and gathers the survey information on screen via the touch screen interface and an electronic model of the piece count form they have previously always filled out manually.

The form factor of the computing device for in-home estimating (pen input via touch screen interface) is ideally suited to this task and almost eliminates the learning curve and fear factor that handicaps many technophobic reps in the implementation of sales automation systems. Input is almost entirely done through push buttons on the screen. Since all the calculations are automated, the sales rep is almost completely done with the estimate when they finish walking through the home. This creates the perception that the expertise level of the rep (an important subconscious factor in the decision to purchase) is far superior to that of other reps.

This also allows an average of 30 additional minutes per appointment for the representative to spend selling. To that end, a full multimedia (video with sound) presentation can be used to demonstrate the high-end materials and techniques to be used to protect the client's valuable possessions.

The estimating is done before the shippers very eyes, in fact, it becomes an interactive process with most clients who are usually fascinated by the computer and the video images of moves in progress. The representative then asks for the client's signature and prints the hard copy for the client via the IFR port to a portable color printer. The color order printout has a great deal of appeal to the eye in comparison to most of the forms used by others, another subtle competitive advantage.

The goal is product differentiation, a difficult task when selling intangible services. The combined software and hardware can go a long way towards illustrating the dedication of a company to exemplary service. More efficient and effective automated representatives often average over 10% more volume from the same number of sales leads. They can also make more sales calls per day with less fatigue and greater enthusiasm.

### BRIEF DESCRIPTION OF THE DRAWINGS

FIG. 1: Main Menu.

FIG. 2: Form Menu.

FIG. 3: Customer Database.

FIG. 4: Customer File Folder.

FIG. 5: Find Files.

FIG. 6: Appointment Card.

FIG. 7: Cube Sheet.

FIG. 8: Packing Worksheet.

FIG. 9: Messages Directory.

FIG. 10: Estimate worksheet.

FIG. 11: Estimate Menu.

FIG. 12: Cube Sheet.

FIG. 13: Pack Worksheet.

FIG. 14: Pricing Worksheet.

FIG. 15: Order for Service (Estimate tab).

FIG. 16: Auto Presentation.

FIG. 17: Fujitsu Mini-Notebook.

FIG. 18: Block diagram of the information flow by participant.

FIG. 19: Block diagram of the interaction of the system for information flow.

### DETAILED DESCRIPTION OF THE INVENTION

Data gathering, estimating, preparation of order forms, client letters and proposals, marketing pieces and presentations, and internal company communications, are all addressed by the software of this invention and have all been automated to a greater or lesser degree.

The sales process begins with marketing pieces designed to target market via direct mail to potential clients in order to increase the likelihood that a potential client will call in to inquire as to the services of the company. To this end several templates have been designed to be sent to a client list that is usually procured by the company from a list of homes for sale or other public information sources.

Some companies may wish to have outside sales people gather this information in a targeted manner as they identify neighborhoods they wish to do more business in. In that case the information can be manually gathered and input into a data file for use in the marketing effort. This is especially effective in the case of For Sale by Owner homes or apartment neighborhoods where no published information is available.

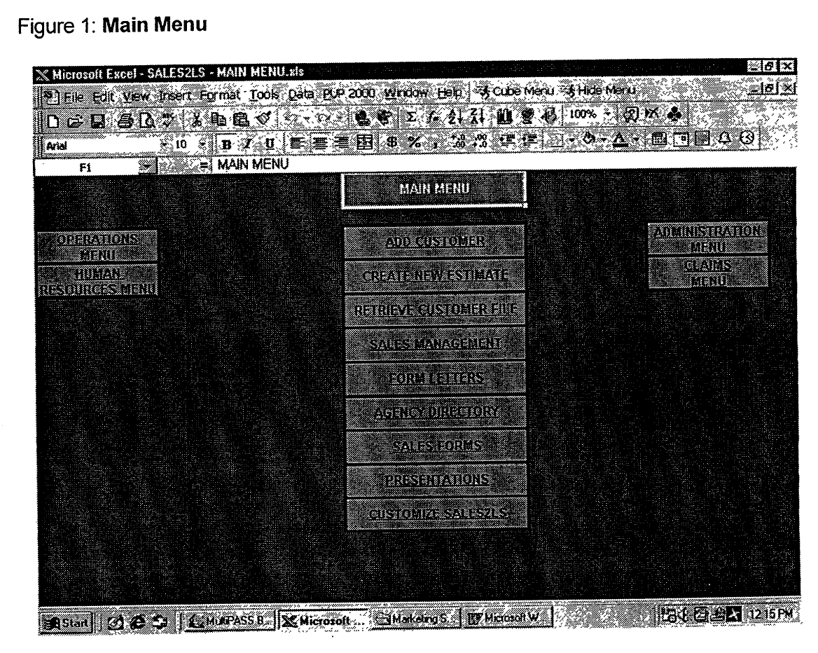

Having imported this client list into a prospect database the sales representative or their support staff can use mail merge automation to produce form letters that will motivate these clients to call in. These pieces are available from the sub menu called Form Letters after opening the Main Menu shown in FIG. 1 from the desktop icon. Several pieces are available from this hyper-linked sub menu and more templates can be added to the program's sub menu as they are developed or customized for the company's particular market.

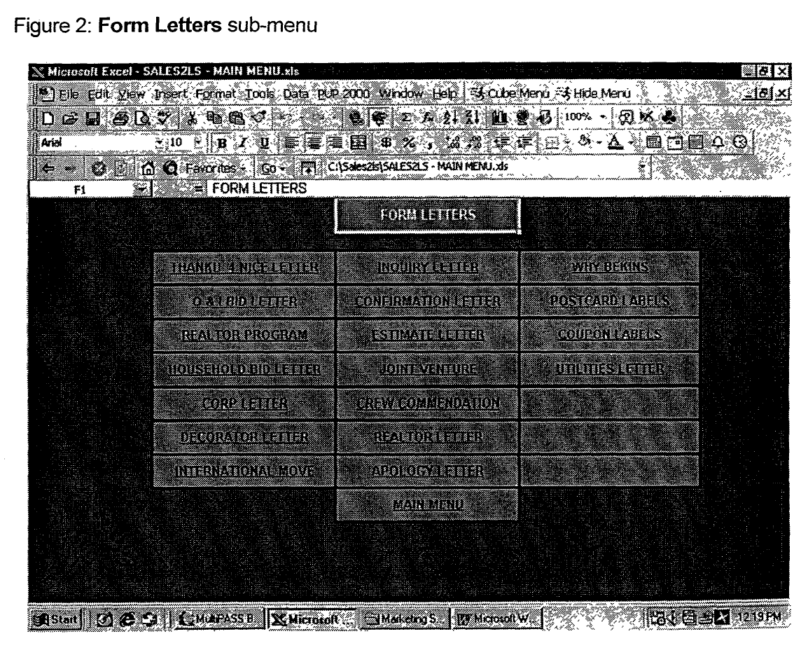

The pieces are identified by descriptive names on the Form Letters sub-menu shown in FIG. 2. There are also prospecting letters available for a similar purpose from this sub menu, (also available from the programs main menu). These letters are typically used to make introductions to professionals who might have business or leads to tender to the company, such as realtors and building managers.

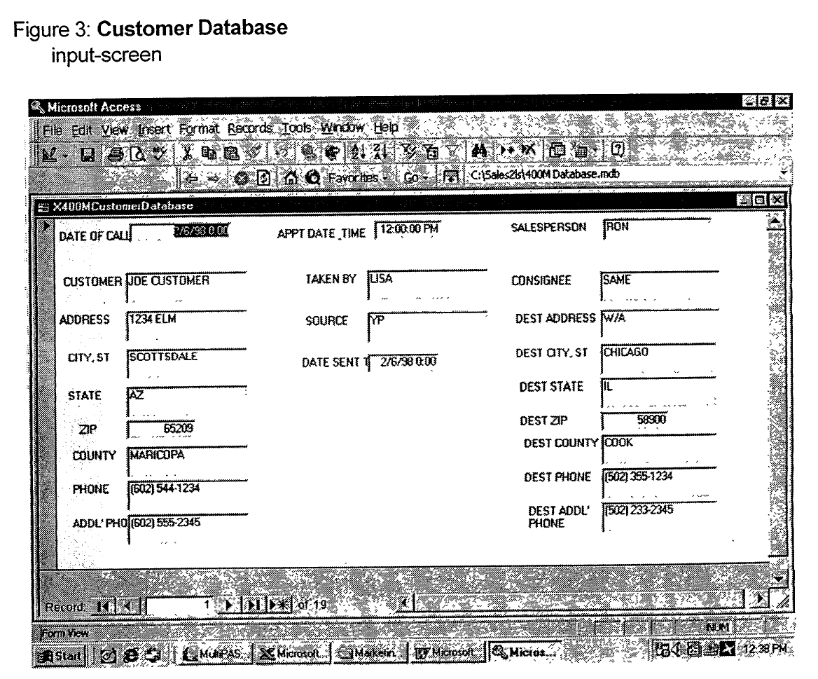

The data gathering process on call in prospects who may have been identified as described above or who are calling for some other reason starts as close to the first point of contact as possible. Ideally, a customer service representative or inside or outside sales person will take their call and begin inputting their specific information into the customer prospects database illustrated in FIG. 3.

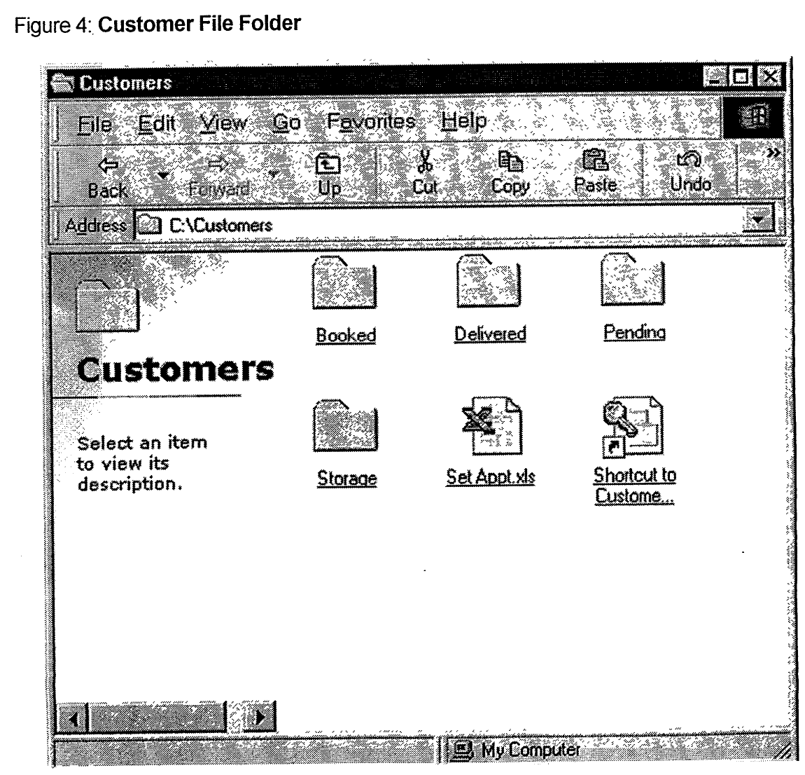

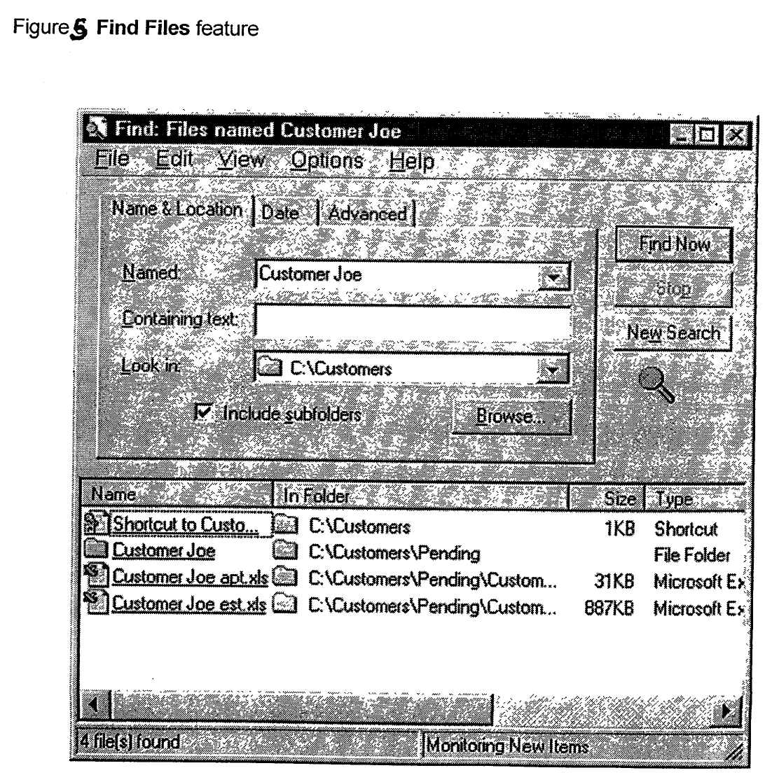

This information, such as where they are moving from and too and when they are planning to move, along with as much other pertinent detail as can be determined is input in the prospects database while the customer is on the phone. If the client requests a ballpark quotation at this point, the record is imported into the appropriate estimating document and a file is begun on this prospective client as the ball park quotation is being given. Should the prospect request an in home appointment at this time this file is stored with the ballpark quotation and a customer file folder FIG. 4 to hold all the customer documents is begun.

Storing the pending customers folder of FIG. 4 on the hard drive of the computer, or on the hard drive of a server allows a company to keep track of all pending customers who have either called in for information, requested a ball park quotation or requested an estimate. The program is set to default to the customer's directory of the hard drive or server when a file is being saved.

Any pending customer who has already called in can be found from the Windows™ Start button via the find files option. As this technique is extremely fast and useful all representatives should be taught the file naming convention in the table below so the files can be easily identified by their file name.

| | | |
|---|---|---|
| File Folder | Last name | First name |
| Appoint. Card | Last name | First/apt |
| Estimate File | Last name | First/est |
| Prospect letter | Last name | First/prospect |
| Proposal | Last name | First/proposal |
| Etc. | Etc. | Etc. |

The customer's directory of FIG. 4 should be further segmented into four sub-directories. These sub directories are respectively named: Pending, Booked, Storage and Delivered. The find feature on Windows 98 and Windows NT machines can be preset to search the Customers folder and all sub-folders, thus speeding the file search process to an almost instantaneous process.

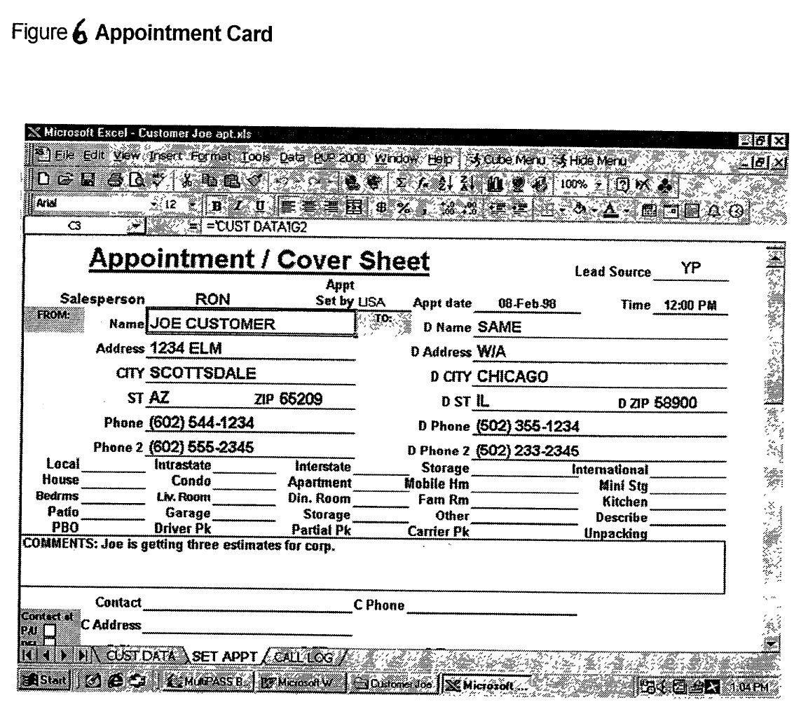

When the find feature returns the customers file folder and the documents within, the naming convention illustrated above allows the user to recognize the appropriate document and double click on the document in the list to instantly access the information within. For instance, if the customer were calling to reset the appointment date and time, seen in FIG. 3 the customer service representative would open the Last name First name apt file to access the appropriate information within. If the appointment is reset the representative can be notified by copying the revised appointment card of FIG. 6 to their messages folder with a message to alert them that the appointment has been rescheduled and the appointment time can be changed in their schedule application.

The salesperson or sales coordinator imports the customer info from the prospect database into the appointment card of FIG. 6 for the outside sales representative's use. A hard copy is usually printed out for distribution or faxing and a copy is saved to the customers folder to document the appointment. Also, a note is inserted into the outside salespersons schedule regarding the appointment day and time.

Currently, the sales persons' schedules are kept in a program called MS Schedule plus, however any scheduling program can be used. In future versions, the scheduling of representative will be integrated into pre-programmed modules and further automated.

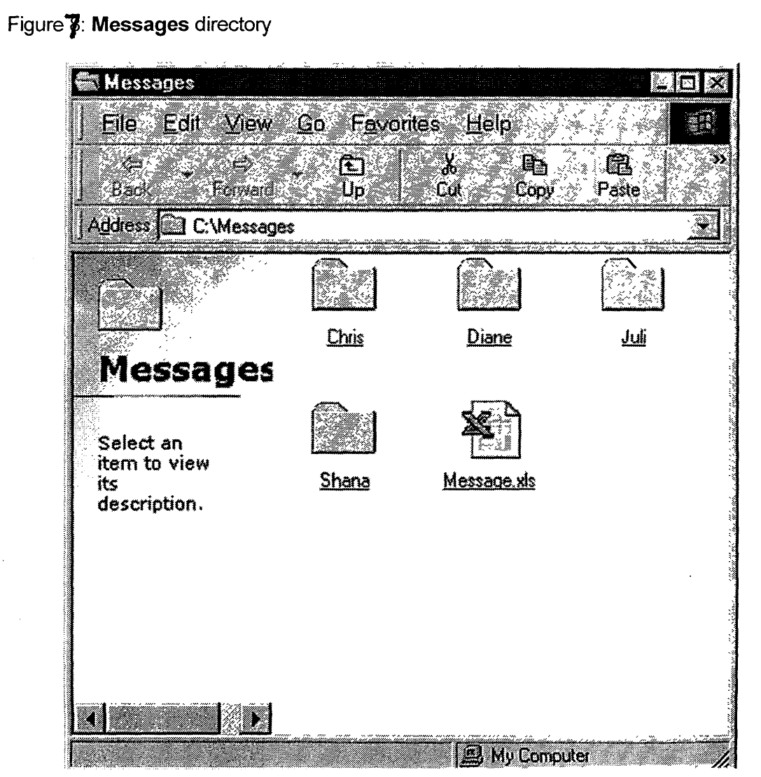

The inside sales representative then copies the prepared folder with estimate form and appointment card to the outside salespersons message directory. In this way, the outside sales representative, while moving his electronic messages as seen in FIG. 7 from the server to his laptop can get a prepared copy of the clients folder, appointment card and a prepared copy of the estimate to use during his call on the prospect. Any pertinent notes on the inside salesperson's conversation with the prospect are noted in the remarks on the appointment card of FIG. 6. At the same time, they pick up their messages from other clients or anyone who called for them while they were out.

After transferring the information to their laptop message directory via the Local Area Network connection, the file folder and contents are saved for use at residence on the sales representative's hard drive in their Pending customer directory of FIG. 4.

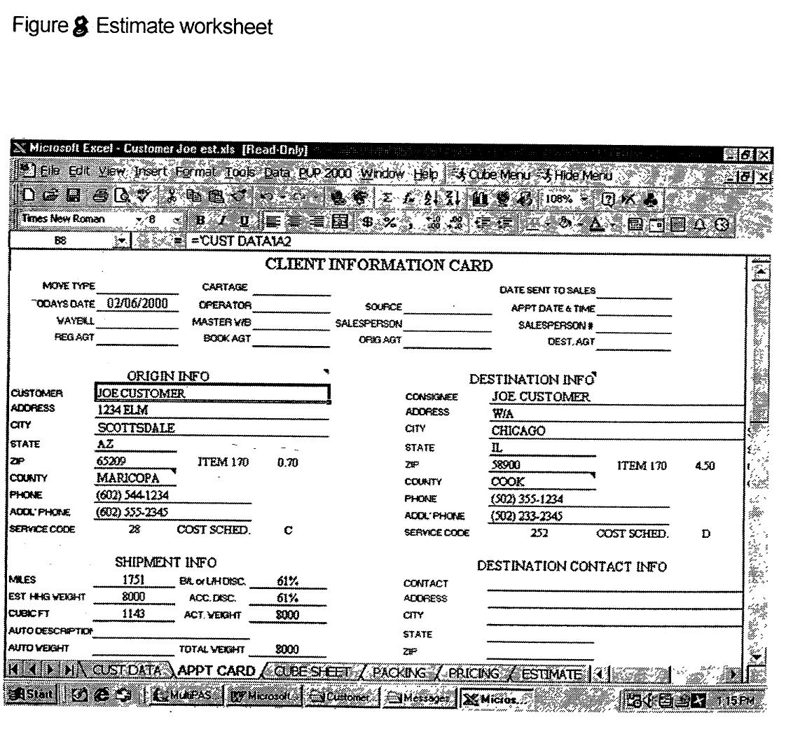

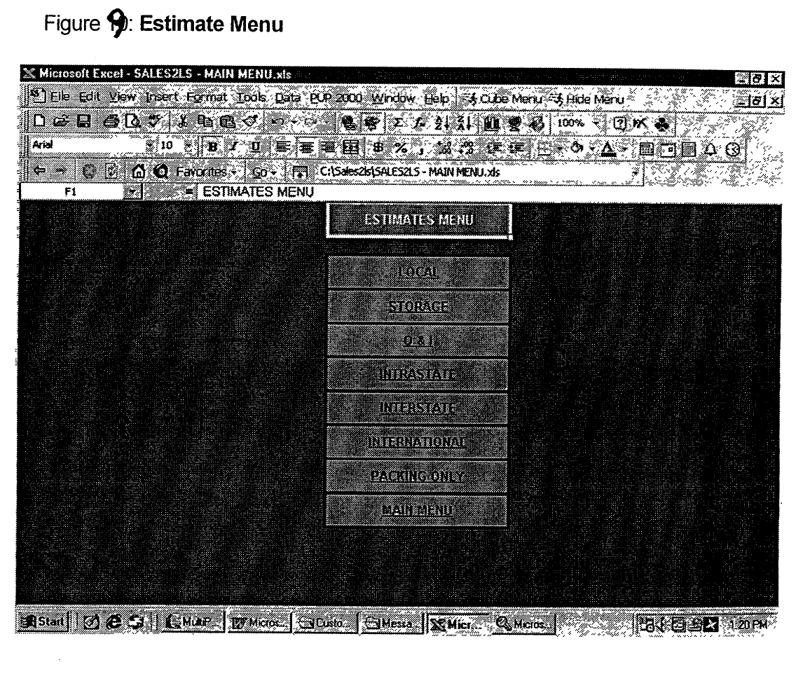

Rand McNally's™ Mile Maker program supplies the correct household goods mileage (see FIG. 8) automatically from the user input of origin and destination city and state information supplied by the client. No need to call the office for a tariff pull from the slow and complex client server on-line information system. No need to initiate a ten-minute lookup process in the mileage guide and five sections of the interstate tariff.

Four thousand five hundred major cities and their associated counties have been input into a database and those counties are returned automatically to the appointment card for complete automation of all required look-ups. The correct county at origin and destination must be input for small town's that are not in the computers' database of major cities.

When Rand McNally's™ Mile Maker for Excel program is completed all cities in the United States will be associated with their correct counties and all county look-ups will be entirely automated from data supplied by Rand McNally™. This will provide the users of the program the completely automated estimating tool desired.

This complete and automatic estimating process is unique in a stand-alone PC based estimating and rating tool, and is believed never to have been accomplished in a non-network dependent or client server system. What is more, all lookups and automation in this system are virtually instantaneous. This is the key to the usefulness of this tool; instantaneous information available to all users for the benefit of their clients.

No longer does it require extensive training in complex tariffs to provide clients with accurate, automatic, deliverable quotations. New hires and entry-level personnel can now deliver accurate quotations quickly, accurately and easily without extensive training. There are estimating applications available for all types of estimates that a sales representative has opportunity to quote on. They all are designed with similar interfaces and push button automation of all look-ups, calculations and estimating functions. All output forms are designed as replicas of the estimate and order forms that sales people in the movers system already use so that they can be printed and used as executable orders.

From the counties at origin and destination, the program looks up the correct service codes, cost schedules and item 170s, which is a designation in the trade for “extra labor”. Once the representative inputs an actual or approximate shipping weight, the pricing for transportation charges is immediately complete and available by clicking on the estimate sheet tab (FIG. 8).

Even the percentage of discount to be applied to the shipment is automated. The sales manager for the company can set the levels of discount that are appropriate for their market in a table on the pricing sheet tab of the interstate estimating template. If the representative wants to change the discount level on a particular shipment to a level differing from the defaults that are preset, they merely click on the cell where the default discount is returned and type in the discount that they wish to quote on. All discounted items are instantly re-calculated according to this new discount level. Should the sales manager wish to prevent this level of user control and retain complete control over the price quotes for the office they can protect this cell and prevent user level changes.

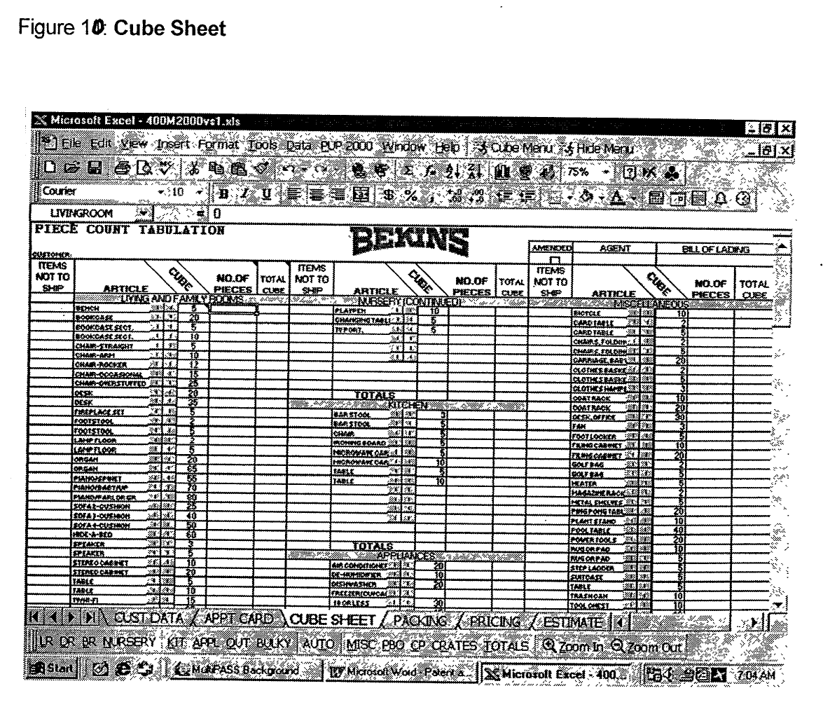

The field salesperson does a walk-through at residence and inputs the pieces (via touch screen and stylus) to the Cube Sheet (FIG. 10). It is easy because it looks exactly like the cube sheet they have used to manually collect information.

The program totals the cubes and calculates weight, instantly recalculating the estimate as they input more pieces or cartons. They can see what they have input and check to make sure they have each piece recorded properly.

The Cube input toolbar helps the user jump from room to room to keep up with their fast talking client. This automation is based on an implementation of Visual Basic for Applications Macro's that have been assigned to coded buttons on the custom cube menu toolbar. In order to make the cube sheet easier to use, Zoom buttons are also assigned to this toolbar. When used in the field during an estimate walkthrough the representative can zoom in with the touch of a button to make the screen larger and easier to use while walking.

Even in the darkest of homes, the lighted screen is easy to read. When the representative is finished with the cube menu toolbar, they can touch the Hide Menu command button on the Main Menu bar to clear the screen and remove the Cube Menu toolbar.

The salesperson checks packing totals that have posted forward from the carrier pack portion of the cube sheet to the Packing Worksheet (FIG. 11).

P.B.O. (Pack By Owner) boxes can be added in the customer column without changing the calculated cube or weight. If the client desires a quote on unpacking, the salesperson can input “Y” in the Unpack Y/N field and unpacking charges for the shipment are instantly added. All rates are based on the appropriate cost schedule for origin and destination counties based on the input on the Appt Card worksheet and will shift to the correct rates if those entries are changed at any time.

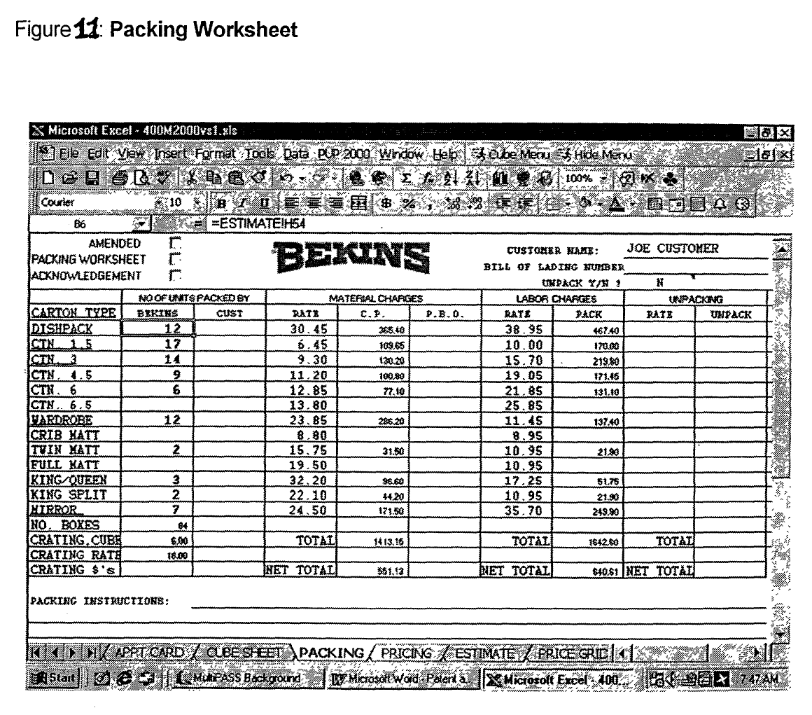

The salesperson then inputs any Accessorials to be charged in the unit's column of the Pricing Worksheet form (FIG. 12).

All calculations are automatic and instantaneous. All common estimating situations have been anticipated and automated as much as possible. All calculations are based on the correct cost schedule item based on the county of origin and destination.

Both of these forms are almost exact replicas of familiar standard movers' paperwork. The input goes into the same fields on the digital forms as it was written into the manual forms.

Even the charges for Storage In Transit at origin and destination are calculated and available at the bottom of the Pricing Worksheet form.

Showing presentation videos can be part of the closing process as needed, because the estimate takes only moments. Blue underlined words on the Packing and Pricing worksheets are hyper linked to appropriate multi-media presentations by context in the same manner that this technology is used on the Internet.

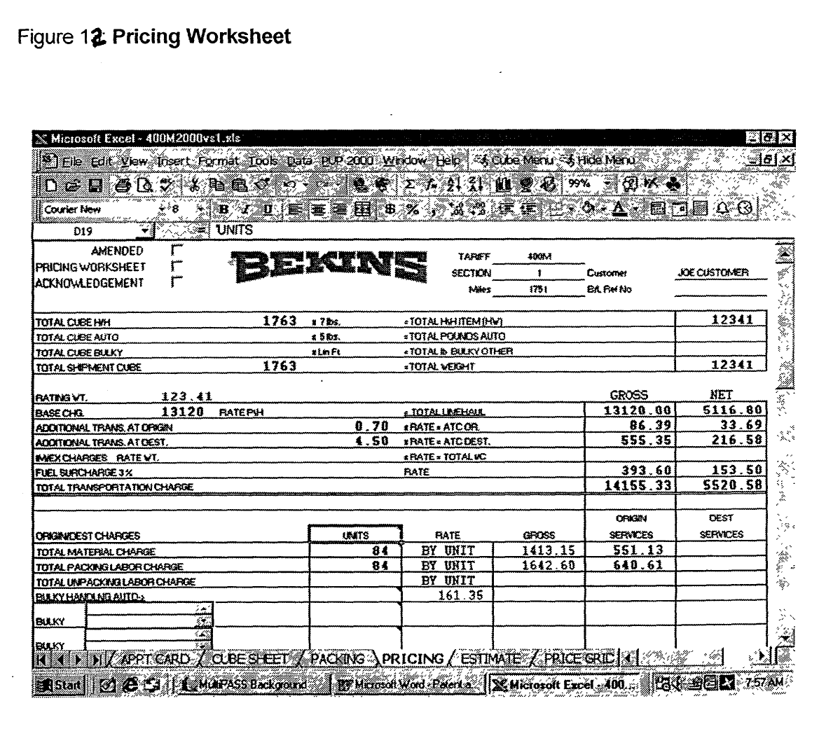

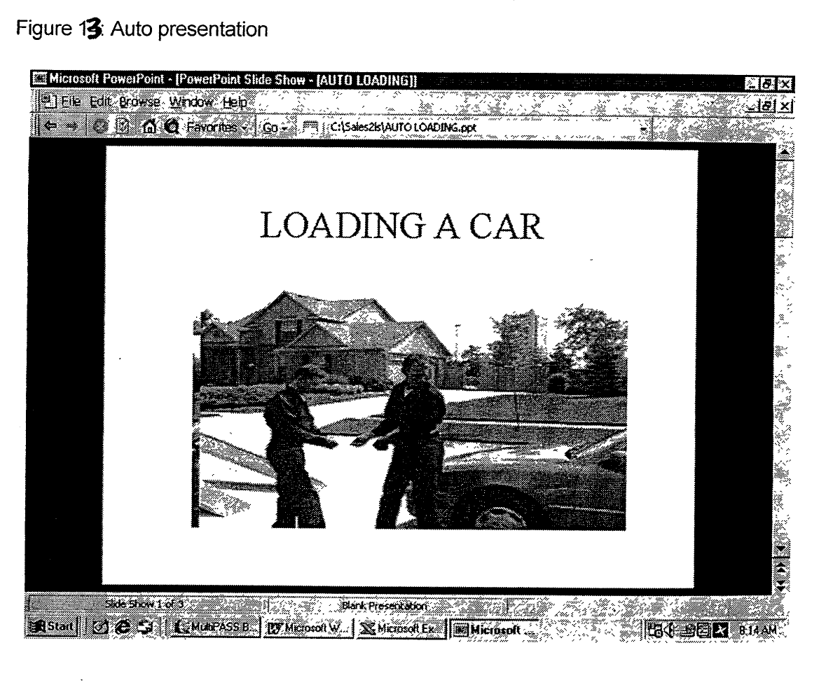

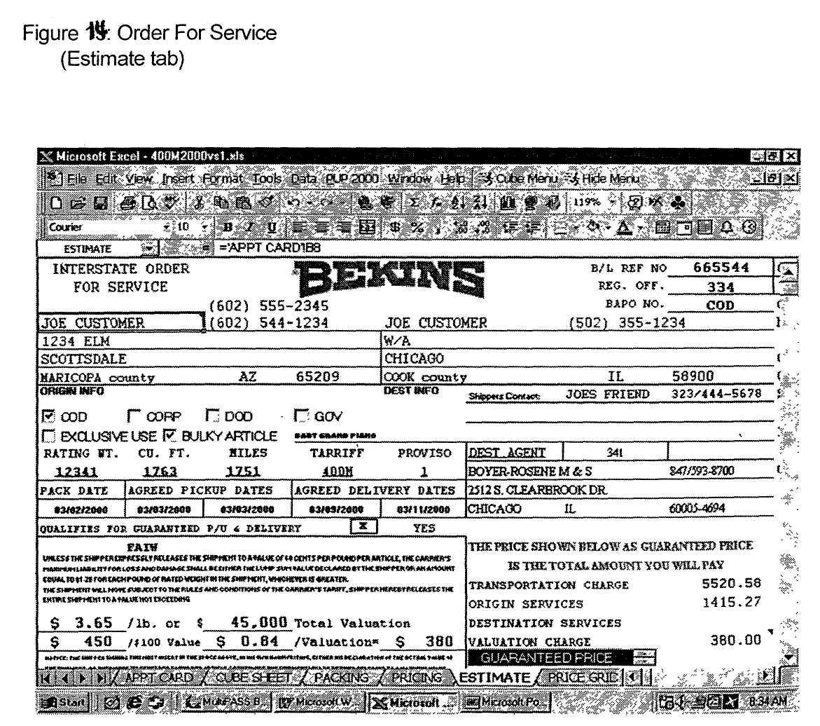

For example, when the representative touches the hyper linked word, “Bulky Handling—Auto” on the Pricing worksheet (FIG. 12) a video presentation on loading automobiles on to the moving van is made available. When the static picture (FIG. 13) comes up on the screen the representative touches the picture to start the audio video presentation. If they would prefer to do their own narration they can turn down the audio volume on their laptop and explain the video to the client themselves. When the representative is finished showing this piece to the client they merely touch the blue arrow pointing backwards on the Web Toolbar of the presentation and they are returned to the estimate exactly where they were previously working.

There are many other presentation pieces such as this available from the Presentations sub-menu of the Main Menu application.

After adding the accessorial items to the Pricing worksheet (FIG. 12) the representative brings up the Order for Service form (FIG. 14) by touching the Estimates tab on the bottom of the screen. The salesperson can, check the delivery guide, do what if scenarios, etc. The estimate is almost ready by the end of the walkthrough.

The salesperson can also check the calculated minimums and pricing on valuation by touching the Valuation worksheet tab. Transit time guidelines are available on the Transit Guide tab. Should the representative need to find a destination agent for the shipment they can touch the Dest. Agent hyper-link and search the agency directory for an appropriate destination agent number to input on the Appt Card tab. Inputting the destination agent number in the correct field calls up that agent's information from the directory and fills out the appropriate area on the Order For Service.

The order can be printed wirelessly via the infrared data transfer port to any printer that accepts IRDA data transfer.

This computing device provides the optimal interface for field salespeople (lightweight, pen-input, color screen). Of course, the software will run on any computer with a Windows operating system and sufficient processor speed and RAM. Presenting your companies offering in the most attractive format is the main goal with clients in their home or business.

Additional software can be added for voice and handwriting recognition. This will allow fast preparation of custom letters or proposals.

Infrared data transfer port (for wireless printing of orders), port replicator for easy connection to external keyboard and monitor or other peripheral devices and internal network interface card for LAN connections and modem for e-mail and Internet connectivity allows a person to work where he/she needs to when he/she needs to: in the car, at a restaurant, at home, in a meeting, even at the beach or on a yacht. There is no need to connect to dial up information systems to get mileage or tariff rates.

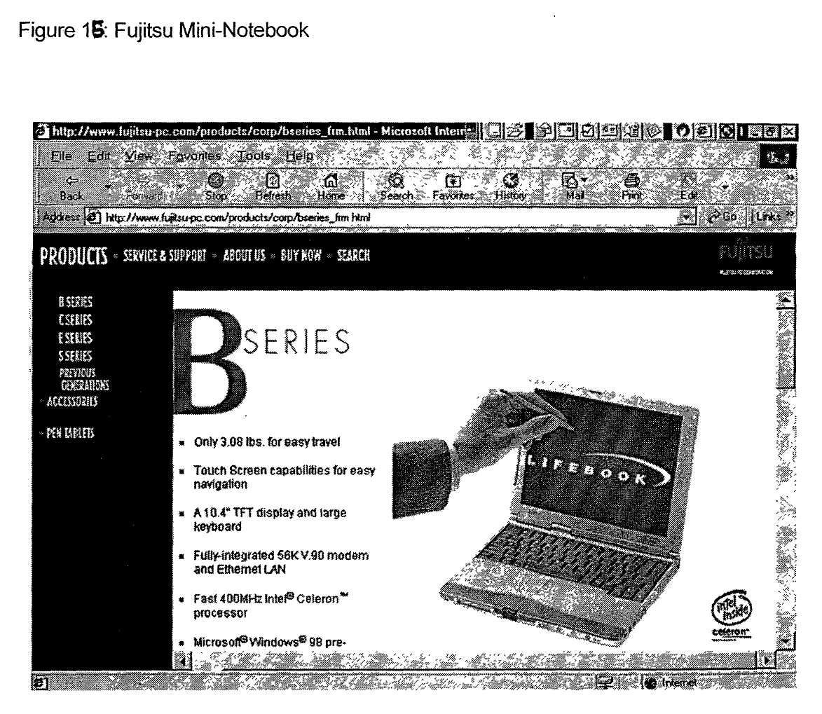

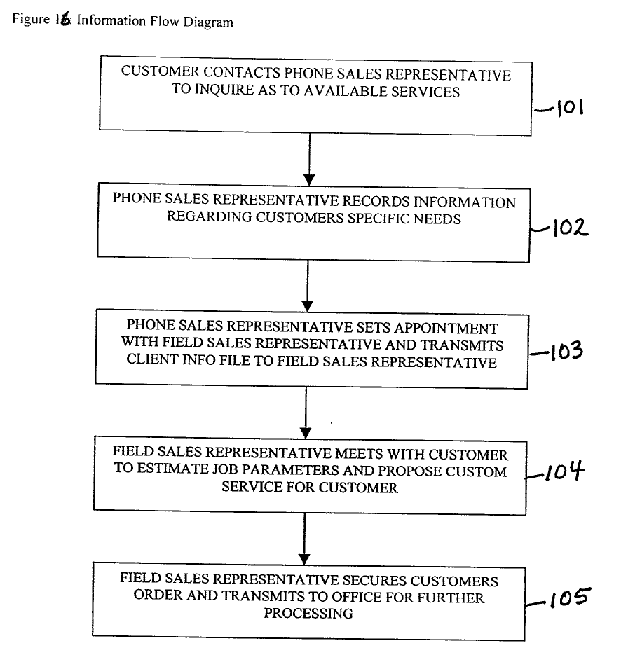

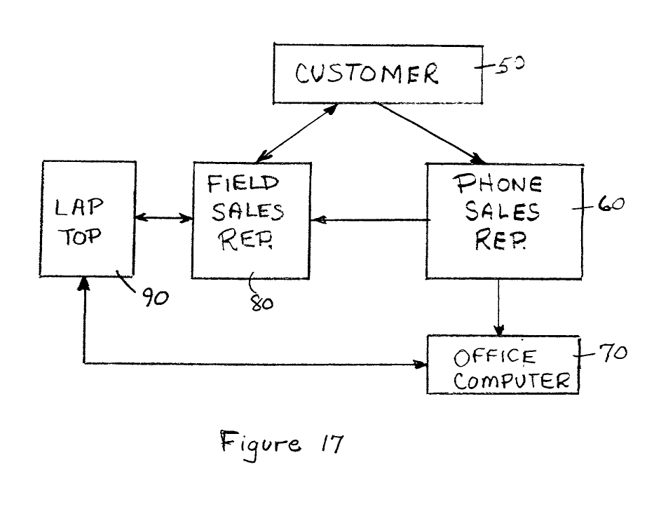

The information flow is illustrated in FIGS. 16 and 17. Initially, the customer 50 contacts the phone sales rep 60 in step 101 to inquire as to available services. The phone sales rep 60 records the information regarding the customer's specific needs in the office computer 70 in step 102, sets an appointment with the field sales rep 80 and transmits the client info file to the field sales rep 80 in step 103. The field sales rep 80 meets with the customer 50 to estimate the job parameters and propose custom service for the customer 50 in step 104, all the time making entries in his/her laptop computer 90. The field sales rep 80 secures the customer's order and transmits from his/her laptop computer 90 to the office computer 70 in step 105 for further processing.

Interaction takes place between the field sales rep 80 laptop computer 90 and the office computer 70 in the manner described in greater detail above.

I claim:

1. An automated sales method for the moving and storing industry comprising:
a. inputting into the computer system of the mover entity the customer identity and needs,
b. entering into the computer system of the mover entity an appointment date for the customer and the field sales representative of the mover entity,
c. transmitting the customer identity, needs and appointment information file to the field sales representative. Entering into the customer file at the customer location the details of the material to be moved,
d. processing the details of the material to be moved to produce an estimate of the details for moving the material and an order for moving the material, and
e. transmitting the estimate and order to the computer of the mover entity for further processing.

2. An automated sales system for the moving and storing industry comprising:
a. means for inputting into the computer system of the mover entity the customer identity and needs,
b. means for entering into the computer system of the mover entity an appointment date for the customer and the field sales representative of the mover entity,
c. means for transmitting the customer identity, needs and appointment information file to the field sales representative. Entering into the customer file at the customer location the details of the material to be moved,
d. means for processing the details of the material to be moved to produce an estimate of the details for moving the material and an order for moving the material, and
e. means for transmitting the estimate and order to the computer of the mover entity for further processing.
